(19) United States
(12) Patent Application Publication
(10) Pub. No.: US 2008/0264553 A1
(43) Pub. Date: Oct. 30, 2008

(54) EMBOSSING

(75) Inventors: Jennifer L. Wu, Corvallis, OR (US); Alan T. Davis, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/741,684

(22) Filed: Apr. 27, 2007

(51) Int. Cl. B44C 3/08

(52) U.S. Cl. 156/220; 156/553

(57) ABSTRACT

Various embossing methods and apparatus are disclosed.

### BACKGROUND

Optical and electronic devices sometimes include structures formed using photolithography. Such photolithography may increase fabrication cost and complexity.

### BRIEF DESCRIPTION OF THE DRAWINGS

FIGS. 1-3 schematically illustrate one method for forming a three-dimensional relief in a structure according to an example embodiment.

FIGS. 4-8 schematically illustrate a method for forming a spectrometer according to an example embodiment.

FIG. 9 is a sectional view schematically illustrating another embodiment of a spectrometer formed according to steps of the method of FIGS. 4-8.

FIG. 10 is a schematic illustration of a fabrication system according to an example embodiment.

### DETAILED DESCRIPTION OF THE EXAMPLE EMBODIMENTS

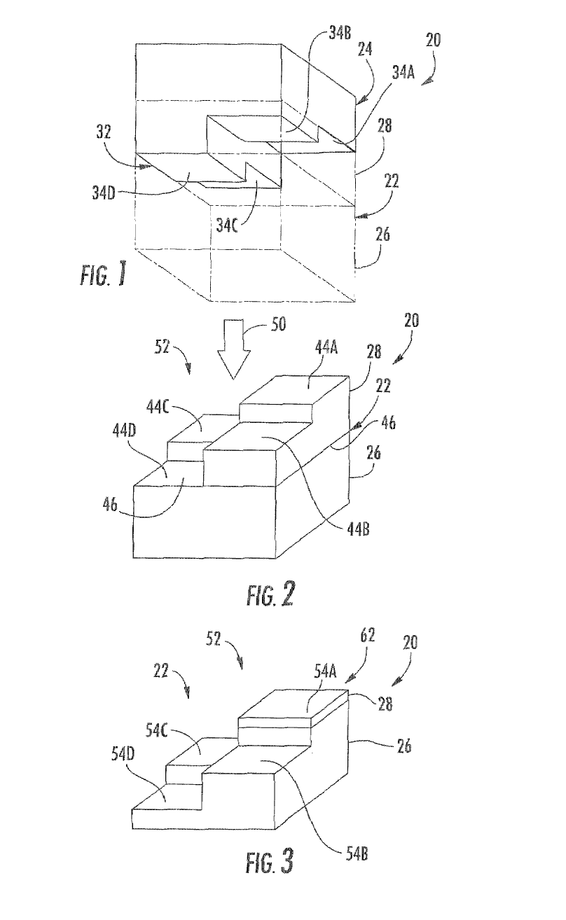

FIGS. 1-3 schematically illustrate a method 20 for forming a three-dimensional structure according to an example embodiment. The method shown provides a repeatable process for fabricating or forming three-dimensional structures or reliefs that may be formed with a reduced reliance upon photolithography. As a result, fabrication cost and complexity is reduced.

FIGS. 1-3 illustrate a method which utilizes embossing to reduce reliance upon photolithography. For the purposes of this disclosure, the use of the term embossing shall also encompass imprinting, where the embosser may alternatively be known as a master. FIG. 1 illustrates a work piece structure 22 being embossed with an embosser 24. Structure 22 includes substrate 26 and embossable layer 28. Substrate 26 comprises a layer of one or more materials supporting embossable layer 28. Substrate 26 provides one or more materials into which three-dimensional structures or multiple levels are to be formed.

In one embodiment, substrate 26 comprises a layer of one or more materials that itself is not embossable. In one embodiment, substrate 26 may be substantially rigid or inflexible For example, in one embodiment, substrate 26 may comprise a layer of silicon dioxide. In other embodiments, substrate 26 may comprise other organic or inorganic inflexible materials. Other inorganic materials including, but not limited to glass, silicon, Al, AlCu, Ag, polysilicon, amorphous silicon, ultra high molecular weight polyethylene, or combinations of layers thereof. In yet other embodiments, substrate 26 may be a flexible or semi-flexible material such as a layer of polymer material or other materials. Examples of organics include plastics, acrylics, vinyls, epoxies, and phenolics including but not limited to polytetraflouroethylene (TEFLON) polypropylene, polyvinylchloride, polyurethane, polyoxymethylene (POM), acetal resin, polytrioxane and polyformaldehyde.(commercially available as DELRIN from Dupont). Although structure 22 is illustrated as having substrate 26 as the lowermost or bottommost layer, in other embodiments, structure 22 may be provided with additional structures on sides of substrate 26 or adjacent to a side of substrate 26 opposite to embossable layer 28.

Embossable layer 28 comprises a layer of one or more materials in a state such that the layer of one or more materials is embossable. In one embodiment, embossable layer 28 comprises a thixotropic material or composition of materials such that after embossment by embosser 24, the layer of embossing layer 28 substantially retains its embossed shape. Examples of such embossable materials include, but are not limited to polyethyleneteraphalate (PET), polymethyl methacrylate (PMMA), polyethylene, polydimethylsiloxane (PDMS), polycarbonate or SU8 photoresist. In particular embodiments, embossable layer 28 may comprise a layer of one or more materials used for imprinting such as curable thermal resists or photoresists. Examples of such materials include, but are not limited to, MONOMAT™, which is commercially available from Molecular Imprints of Austin, Tex. and NXR-1000, NXR-2000 and NXR 3000, each of which is commercially available from Nanonex.

In another embodiment, layer 28 comprises one or more materials which are not thixotropic. In such an embodiment, the one or more materials of embossable layer 28 are configured to sufficiently solidify or be cured to a state to retain the embossed shape after embossment. For example, in one embodiment, the layer 28 of embossable materials may comprise a material which, upon exposure to heat and while in contact with embosser 24, solidifies, permitting embosser 24 to be separated from structure 22 without the embossed shape in layer 28 being lost or degraded.

In yet another embodiment, embossable layer 28 may comprise one or more materials which upon exposure to electromagnetic radiation, such as ultraviolet light, while in contact with embosser 24, cures to a sufficiently stable or rigid state such that layer 28 retains its embossed shape upon separation from embosser 24. For example, in one embodiment, layer 28 may comprise a UV curable resist. In one embodiment, layer 28 may comprise a positive photoresist that, after exposure to UV radiation, can be dissolved by solvent. In another embodiment, layer 28 may comprise a negative photoresist. In embodiments where substrate 26 is transparent or transmissive of UV light, the UV curable material or materials of layer 28 may be cured by applying ultraviolet radiation through substrate 26. In yet other embodiments where embosser 24 is transparent or transmissive of UV light, layer 28 may be cured by applying ultraviolet radiation through embosser 24. In still other embodiments, layer 28 may comprise doped semiconductors, metals or other materials or combinations of materials configured to serve as an embossable layer.

According to one embodiment, layer 28 of embossable material or materials is preformed upon substrate 26. In yet other embodiments, layer 28 may be formed upon substrate 26. In one embodiment, layer 28 may be deposited upon substrate 26 by any of various deposition techniques including, but not limited to, spraying, sputtering, chemical vapor deposition, physical vapor deposition, evaporation, electroplating, spin coating, liquid dispense and the like.

Embosser 24 comprises a structure having a relief surface 32 configure to form features within embossable layer 28. In the particular example shown, relief surface 32 includes steps 34A, 34B, 34C and 34D (collectively referred to as steps 34). Steps 34 have distinct heights. In the example illustrated, step 34B projects beyond the step 34A. Step 34C projects beyond step 34B. Step 34D projects beyond step 34C. Such steps 34 emboss or imprint a corresponding complementary, negative or opposite pattern in embossable layer 28 during embossment. Although steps 34 of relief surface 32 are illustrated as having substantially the same area, as being rectangular, and as having substantially the same incremental height or thickness differences, in other embodiments, relief surface 32 may have projections or depressions having other shapes, having different relative dimensions and projecting different distances with respect to one another.

According to one embodiment, embosser 24 may be formed from a variety of rigid materials including, but not limited to, SU-8, silicon, silicon dioxide on silicon, gallium arsenide, metal on silicon, quartz, and fused silica. According to one embodiment in which embossable layer 28 is configured to be cured upon exposure to electromagnetic radiation, such as ultraviolet light, embosser 24 may be configured to transmit such electromagnetic radiation. For example, in one embodiment, embosser 24 may be transparent or otherwise transmissive of ultraviolet light. For example, one embodiment, embosser 24 may be quartz or fused silica. In other embodiments, embosser 24 may be formed from other materials. Imprinting master templates can be obtained from Lawrence Berkeley National Labs (LBNL) and Motorola Labs.

FIG. 1 illustrates embosser 24 pressed into embossable layer 28 so as to emboss a complementary but opposite or negative relief pattern in layer 28. In the particular example illustrated, such embossment will form multiple steps that are complementary to steps 34. During such embossment, embossable layer 28 is solidified, cured or otherwise made sufficiently stable such that layer 28 retains its shape upon separation from embosser 24. As noted above, in particular embodiments, layer 28 may be cured by applying ultraviolet light either through substrate 26 or through embosser 24. In other embodiments, layer 28 may sufficiently solidify with the application of heat or other treatments while in contact with embosser 24. In yet other embodiments, layer 28 may be sufficiently thixotropic so as to retain its shape upon separation from embosser 24, wherein layer 28 may or may not be additionally solidified or cured after such separation.

FIG. 2 schematically illustrates structure 22 after separation from embosser 24. As shown by FIG. 2, the embossed structure 22 includes substrate 26 and the embossed layer 28. Embossed layer 28 includes steps 44A, 44B, 44C and 44D (collectively referred to as steps 44). Steps 44A, 44B, 44C and 44D correspond to steps 34A, 34B, 34C and 34D, respectively. Steps 44 have shapes, sizes and relative dimensions that are substantially similar to the shapes, sizes and relative dimensions of steps 34. In the particular example illustrated, steps 44A, 44B and 44C are elevated or spaced from surface 46 of substrate 26. Step 44D extends along or is provided by surface 46 of the substrate 26. In other embodiments, step 44D may be spaced from surface 46 of substrate 26 by a relatively thin layer of the embossed material layer 28. As noted above, the embossed pattern or construct formed in layer 28 may have any of a variety of different configurations depending upon the relief surface 32 of embosser 24. The relief structure is not meant to be limited to the illustration in FIG. 1. It may have more or less steps but in general is a multilevel master/embosser.

FIG. 2 further schematically illustrates sacrificial treatment of structure 22. In particular, as schematically represented by arrow 50, structure 22 is sacrificially treated from the side 52 of structure 22 having layer 28. For purposes of this disclosure, the term “sacrificial treatment” or “sacrificially treated” refers to one or more processes by which material is separated and removed from a work piece or structure by the substantially uniform application of chemicals or energy across a surface area of the work piece or structure. For example, such sacrificial treatment may be performed by substantially uniformly applying an etchant solution across a surface area of a structure, wherein the etchant solution removes the materials to be sacrificed such that the materials may be separated with subsequent washing or other treatment. Such sacrificial treatment may also be performed by potentially uniformly applying energy to the surface area to a ablate, burn or loosen materials to be sacrificed. Energy may be applied in the form of a laser or other electromagnetic radiation which is sequentially applied during scanning of an energy applicator across a surface area or a blanket application of laser energy or other electromagnetic radiation.

According to one example embodiment, such sacrificial treatment is performed by etching. One or more etchants are applied to side 52 of structure 22. The etchants dissolve and remove material from both layers 28 and substrate 26 upon contact and exposure to such materials. Because portions of embossed layer 28 have different thicknesses or heights above substrate 26, such etchants come into contact with the substrate 26 at different times or not all. For example, etchants may immediately come into contact with substrate 26 adjacent to step 44D. Other portions of the substrate 26 will not contact the etchants until later in time. Those portions of substrate 26 exposed or in contact with the etchants for the longest period of time will undergo a greater degree of etching or sacrificial treatment. Likewise, those portions of substrate 26 exposed for the least amount of time will undergo the least amount of sacrificial treatment or material removal. In particular embodiments, such sacrificial treatment may be performed for an insufficient time or insufficient intensity so as to remove all of layer 28. As a result, portions of substrate 26 may not come into contact with the etchant. The different degrees by which substrate 26 comes into contact with the etchants results in the formation of a pattern or image along surface 46 of substrate 26 which corresponds to the embossed pattern in layer 28.

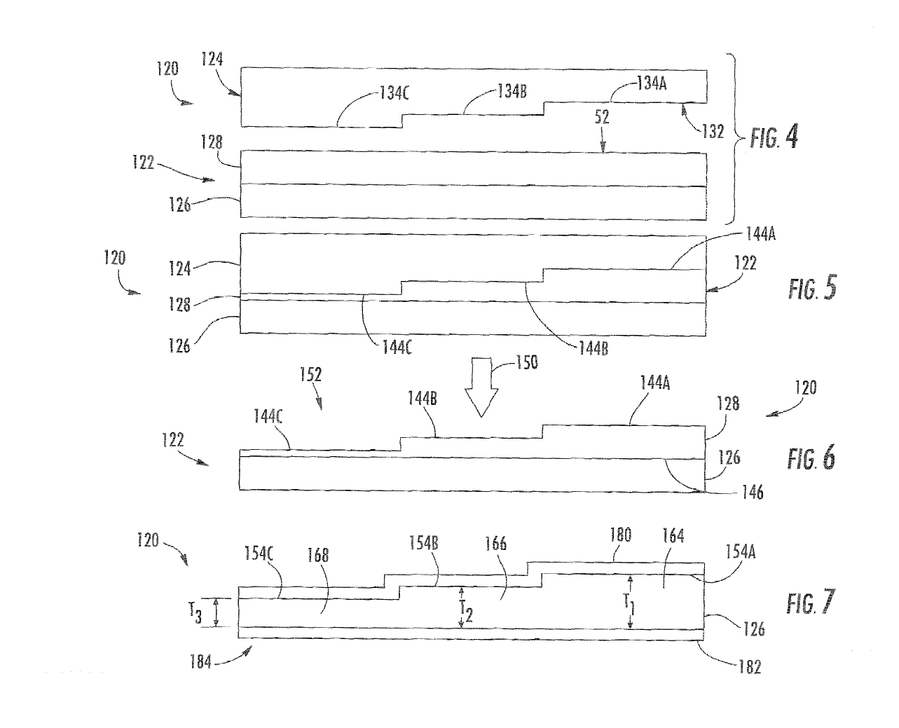

FIG. 3 illustrates structure 22 after sacrificial treatment. As shown by FIG. 3, the sacrificially treated structure 22 includes sacrificially treated substrate 26 and the remains of sacrificially treated layer 28. The sacrificially treated structure 22 includes steps 54A, 54B, 54C and 54D (collectively referred to as steps 54). Steps 54 correspond to previously existing steps 44 in location and a surface area facing side 52. In one embodiment, substrate 26 and the material of embossed layer 28 are configured to be sacrificed (dissolved, decomposed or loosened) at substantially the same rate during such sacrificial treatment. For example, the materials of substrate 26 and that of layer 28 may be configured to react to the applied etchant in a substantially similar fashion (may be configured to have the same etch rate). Alternatively, the material of substrate 26 and layer 28 may be configured to be decomposed or be ablated at the same rate upon exposure to an applied energy. As a result, the height differences between steps 54 correspond in a relative way to the height differences between the previously existing steps 44 in embossed into layer 28.

In another embodiment, either (1) the sacrificial treatment utilized, such as a type of etchant, the type of energy applied or the intensity or duration of energy applied or (2) the materials selected for substrate 26 and layer 28 may be configured such that layers 26 and 28 are sacrificed at different rates with respect to one another upon exposure to the sacrificial agent (etchant or energy). For example, in one embodiment, substrate 26 may be configured to be dissolved, decomposed or loosened at a greater rate upon exposure to energy or an etchant as compared to the rate at which layer 28 undergoes dissolving, decomposition or loosening (the etch is selective to layer 26, not 28). In another embodiment, the materials of layer 28 may be configured to be dissolved, decomposed or removed at a greater rate upon exposure to energy or an etchant as compared to the rate at which substrate 26 undergoes dissolving, decomposition or removal. As a result, the height differences exhibited by steps 54 may not correspond to the height differences between the previously existing steps 44 in embossed into layer 28. The height differences in steps 54 may be exaggerated or alternatively assuaged as compared to the height differences of embossed steps 44.

In the particular example illustrated, the sacrificial treatment of a substrate 26 and embossed layer 28 is performed at an intensity or for a duration such that a portion of the embossed layer 28 remains following sacrificial treatment. In the example illustrated, this portion forms step 54A. In other embodiments, a greater portion of embossed layer 28 may remain, wherein additional features are steps are defined by the remaining portions of layer 28. In still other embodiments, substantially the entirety of layer 28 may be sacrificed, leaving just substrate 26 alongside 52. Complete removal of layer 28 and complete exposure of substrate 26 may be beneficial in applications where substrate 26 has beneficial material properties different from those of layer 28. In other embodiments, it may be desirable to utilize different material properties of both substrate 26 and layer 28 by differently exposing portions of substrate 26 or spacing portions of substrate 26 from side 52 of structure 22.

As shown by FIG. 3, the method 20 performed in FIGS. 1-3 results in a structure 22 having multilevel three-dimensional surface features 62 along side 52. Features 62 are formed without use of photolithography. Features 62, such as steps 54, have dimensions that may be precisely and accurately controlled. Moreover, such features 62 may be repeatedly formed in other structures using the same embosser 24 or a similar embosser.

Because structure 22 is provided with such features 62, structure 22 may be employed in a wide variety of optical and electrical components. For example, structure 22 may be employed as part of an interferometer which may have uses in display applications and sensor applications (such as a spectrometer). Structure 22 may also be employed as part of a stepped structure by which different electrical fields are applied to a charge responsive or electro-optical material (such as a liquid crystal material) so as to differently transmit or attenuate light in various display applications. By eliminating or reducing the use of photolithography, method 20 produces fabrication costs for such devices.

Although FIGS. 1-3 illustrate one particular embossing method to form steps 44 which are subsequently sacrificed, in other embodiments and other embossing steps may be employed. For example, other embossing or imprinting methods may include thermal nanoimprint lithography, photocurable nanoimprint lithography or three-layer image reversal imprint lithography. In direct “step and flash” imprinting, MONOMAT, a photo curable, low viscosity imprint resist, is used in conjunction with DUV 30-J (a hard mask material) to directly transfer a pattern to an underlying substrate. In three-layer image “step and flash” reversal imprinting, MONOMAT and DUV 30-J are used in conjunction with a coating of SILSPIN, which is planarized and etched, to transfer a reverse image of the master into the underlying substrate (like a negative resist).

FIGS. 4-8 schematically illustrate a method 120 for forming a spectrometer 186 (shown in FIG. 8). FIG. 4 schematically illustrates provision of a structure 122 and an embosser 124. Structure 122 includes substrate 126 and embossable layer 128. Substrate 126 comprises a layer of one or more materials supporting embossable layer 128. Substrate 126 provides one or more materials into which three-dimensional structures or multiple levels are to be formed.

In one embodiment, substrate 126 comprises a layer of one or more transparent materials. In one embodiment, substrate 126 may be substantially rigid or inflexible. For example, in one embodiment, substrate 126 may comprise a layer of silicon dioxide. In other embodiments, substrate 126 may comprise other organic or inorganic inflexible materials. Other inorganic inflexible materials may include Al, AlCu, Ag, polysilicon, amorphous silicon or combinations or layers thereof. In yet other embodiments, substrate 26 may be a flexible material such as a layer of polymer material or other materials. Examples of organics include plastics, acrylics, vinyls, epoxies, and phenolics including but not limited to polytetraflouroethylene (TEFLON) polypropylene, polyvinylchloride, polyurethane, polyoxymethylene (POM), acetal resin, polytrioxane and polyformaldehyde.(commercially available as DELRIN from Dupont), and ultra high molecular weight polyethylene. In yet other embodiments, substrate 126 may be a flexible transparent material such as a layer of polymer material or other materials. Although structure 122 is illustrated as having substrate 126 as the lowermost or bottommost layer, in other embodiments, structure 122 may be provided with additional transparent structures adjacent to a side of substrate 126 opposite to embossable layer 128.

Embossable layer 128 comprises a layer of one or more materials in a state such that the layer of one or more materials is embossable. In one embodiment, embossable layer 128 comprises a thixotropic material or composition of materials such that after embossment by embosser 124, the layer 28 of embossing material substantially retains its embossed shape. Examples of such embossable materials include, but are not limited to, polyethyleneteraphalate (PET), polymethyl methacrylate (PMMA), polyethylene, polydimethylsiloxane (PDMS), polycarbonate or SU8 photoresist. In particular embodiments, embossable layer 28 may comprise a layer of one or more materials used for imprinting such as curable thermal resists or photoresists. Examples of such materials include, but are not limited to, MONOMAT™, which is commercially available from Molecular Imprints of Austin, Tex. and NXR-1000, NXR-2000 and NXR 3000, each of which is commercially available from Nanonex.

In another embodiment, layer 128 comprises one or more materials which are not thixotropic. In such an embodiment, the one or more materials of embossable layer 128 are configured to sufficiently solidify or be cured to a state to retain embossed shape after embossment. For example, in one embodiment, the layer 128 of embossable materials may comprise a material which, upon exposure to heat and while in contact with embosser 124, solidifies, permitting embosser 124 to be separated from structure 122 without the embossed shape in layer 128 being lost or degraded.

In yet another embodiment, embossable layer 128 may comprise one or more materials which upon exposure to electromagnetic radiation, such as ultraviolet light, while in contact with embosser 124, cures to a sufficiently stable or rigid state such that layer 128 retains its embossed shape upon separation from embosser 124. For example, in one embodiment, layer 128 may comprise a UV curable resist. In one embodiment, layer 28 may comprise a positive photoresist that, after exposure to UV radiation, can be dissolved by solvent. In another embodiment, layer 128 may comprise a negative photoresist. In such embodiments, the UV curable material or materials of layer 128 may be cured by applying ultraviolet radiation through substrate 126 in embodiments where substrate 126 is transparent or transmissive of UV light. In yet other embodiments, layer 128 may be cured by applying ultraviolet radiation through embosser 124 in embodiments where embosser 124 is transparent or transmissive of UV light. In still other embodiments, layer 28 may comprise doped semiconductors, metals or other materials or combinations of materials configured to serve as an embossable layer.

According to one embodiment, layer 128 of embossable material or materials is preformed upon substrate 126. In yet other embodiments, layer 128 may be formed upon substrate 126. In one embodiment, layer 128 may be deposited upon substrate 126 by any of various deposition techniques including, but not limited to, spraying, sputtering, chemical vapor deposition, physical vapor deposition, evaporation, electroplating, spin coating, liquid deposition and the like.

Embosser 124 (also known as a “master” in nanoimprinting) comprises a structure having a relief surface 132 configured to form features within embossable layer 128. In the particular example shown, relief surface 132 includes steps 134A, 134B and 134C (collectively referred to as steps 134. Steps 134 have distinct heights. In the example illustrated, step 134B projects beyond the step 134A. Step 134C projects beyond step 134B. Steps 134 emboss or imprint a corresponding complementary, negative or opposite pattern in embossable layer 128 during embossment. Although steps 134 of relief surface 132 are illustrated as having substantially the same area, as being rectangular, and as having substantially the same incremental height or thickness differences, in other embodiments, relief surface 132 may have projections or depressions having other shapes, having different relative dimensions and projecting different distances with respect to one another.

Although relief surface 132 is illustrated with three such steps 134 for purposes of illustration, in other embodiments, surface 132 may include 16 steps 134, each step corresponding to a distinct portion of the visible spectrum of light or color. In one embodiment, such steps may be arranged in a linear array of 16 steps. In another embodiment, such steps may be arranged in a 4×4 array of steps 134.

According to one embodiment, embosser 124 may be formed from a variety of rigid materials including, but not limited to, SU-8, silicon, silicon dioxide on silicon, gallium arsenide, metal on silicon, quartz, and fused silica. According to one embodiment in which embossable layer 128 is configured to be cured upon exposure to electromagnetic radiation, such as ultraviolet light, embosser 124 may be configured to transmit such electromagnetic radiation. For example, in one embodiment, embosser 124 may be transparent or otherwise transmissive of ultraviolet light. For example, one embodiment, embosser 124 may be quartz or fused silica In other embodiments, embosser 124 may be formed from other materials. Imprinting master templates can be obtained from Lawrence Berkeley National Labs (LBNL) and Motorola Labs.

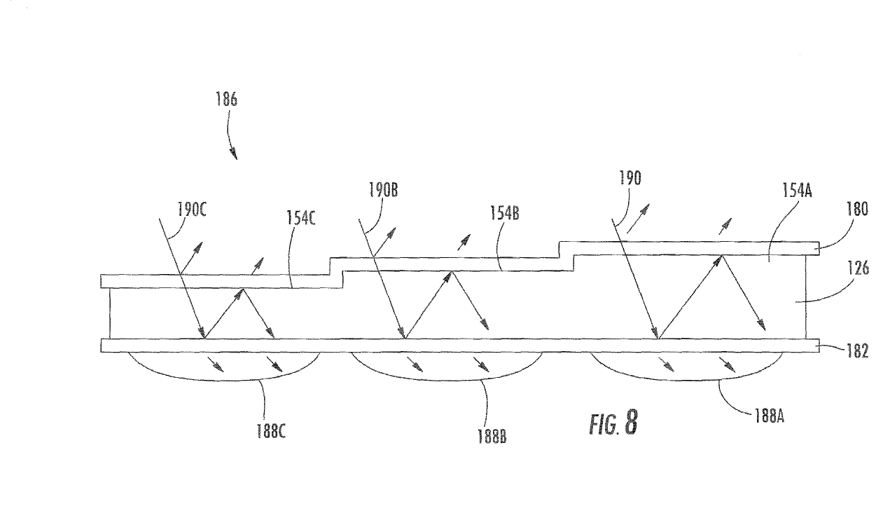

FIG. 5 illustrates embosser 124 pressed into embossable layer 128 so as to emboss a complementary but opposite or negative relief pattern in layer 128. In the particular example illustrated, such embossment will form multiple steps that are complementary to steps 134. During such embossment, embossable layer 128 is solidified, cured or otherwise made sufficiently stable such that layer 128 retains its shape upon separation from embosser 124. As noted above, in particular embodiments, layer 128 may be cured by applying ultraviolet light either through substrate 126 or through embosser 124. In other embodiments, layer 128 may be sufficiently solidified with the application of heat or other treatments while in contact with embosser 124. In yet other embodiments, layer 128 may be sufficiently thixotropic so as to retain its shape upon separation from embosser 124, wherein layer 128 may or may not be additionally solidified or cured after such separation.

FIG. 6 schematically illustrates structure 122 after separation from embosser 124. As shown by FIG. 6, the embossed structure 122 includes substrate 126 and the embossed layer 128. Embossed layer 128 includes steps 144A, 144B, and 144D (collectively referred to as steps 144). Steps 144A, 144B, and 144C correspond to steps 134A, 134B and 134C, respectively. Steps 144 have shapes, sizes and relative dimensions that are substantially similar to the shapes, sizes and relative dimensions of steps 134. In the particular example illustrated, steps 144A, 144B and 144C are elevated from surface 146 of substrate 126. As noted above, the embossed pattern or construct formed in layer 128 may have any of a variety of different configurations depending upon the configuration of relief surface 132 of embosser 124.

FIG. 6 further schematically illustrates sacrificial treatment of structure 122. In particular, as schematically represented by arrow 150, structure 122 is sacrificially treated from the side 152 of structure 122 having layer 128. According to one example embodiment, such sacrificial treatment is performed by etching. One or more etchants are applied to side 152 of structure 122. The etchants remove material from both layer 128 and substrate 126 upon contact and exposure to such materials. Because portions of embossed layer 128 have different thicknesses or heights above substrate 126, such etchants come into contact with the substrate 126 at different times. Those portions of substrate 126 exposed or in contact with the etchants for the longest period of time will undergo a greater degree of etching or sacrificial treatment. Likewise, those portions of substrate 126 exposed for the least amount of time will undergo the least amount of sacrificial treatment or material removal. The different degrees or time durations by which substrate 126 comes into contact with the etchant results in the formation of a pattern or image along surface 146 of substrate 126 which corresponds to the embossed pattern in layer 128.

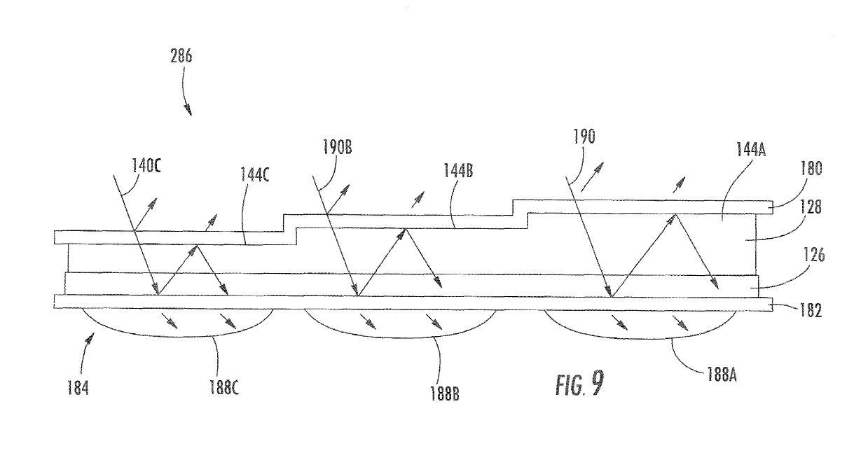

FIG. 7 illustrates structure 122 after sacrificial treatment and metal deposition. As shown by FIG. 7, the sacrificially treated structure 122 includes sacrificially treated substrate. Layer 128 is substantially sacrificed or removed. The sacrificially treated structure 122 includes steps 154A, 154B and 154C (collectively referred to as steps 154). Steps 154 correspond to previously existing steps 144 in their location and their surface area facing side 152. In one embodiment, substrate 126 and the material of embossed layer 128 are configured to be sacrificed (dissolved, decomposed or loosened) at substantially the same rate during such sacrificial treatment. For example, the materials of substrate 126 and that of layer 128 may be configured to react to the applied etchant in a substantially similar fashion. Alternatively, the material of substrate 126 and layer 128 may be configured to be decomposed or be ablated at substantially the same rate upon exposure to an applied energy. As a result, the height differences between steps 54 substantially correspond to the height differences between the previously existing steps 44 in embossed into layer 128.

In another embodiment, either (1) the sacrificial treatment utilized, such as a type of etchant, the type of energy applied or the intensity or duration of energy applied or (2) the materials selected for substrate 126 and layer 128 may be configured such that substrate 126 and layer 128 are sacrificed at different rates with respect to one another upon exposure to the sacrificial agent (etchant or energy). For example, in one embodiment, substrate 126 may be configured to be dissolved, decomposed or removed at a greater rate upon exposure to energy or an etchant as compared to the rate at which layer 128 undergoes dissolving, decomposition or removal. In another embodiment, the materials of layer 128 may be configured to be dissolved, decomposed or loosened at a greater rate upon exposure to energy or an etchant as compared to the rate at which lay substrate 126 undergoes dissolving, decomposition or loosening. As a result, the height differences exhibited by steps 154 may not correspond to the height differences between the previously existing steps 144 in embossed into layer 128. The height differences in steps 154 may be exaggerated or alternatively assuaged as compared to the height differences of embossed steps 144. For example, the materials of substrate 126 and that of layer 128 may be configured to react to the applied etchant in a substantially similar fashion (may be configured to have the same etch rate). Alternatively, in one embodiment, substrate 126 may be configured to be dissolved, decomposed or loosened at a greater rate upon exposure to energy or an etchant as compared to the rate at which layer 128 undergoes dissolving, decomposition or loosening (the etch is selective to layer 126, not 128).

According to one embodiment, the height differences in steps 154 result in corresponding thickness differences in substrate 126. In particular, portion 164 of substrate 126 opposite to step 154A has a thickness T1 of between about 350 nm and 400 nm, portion 166 a substrate 126 opposite to step 154B has a thickness T2 of between about 300 and 350 nm and portion 168 of substrate 126 opposite to step 154 has a thickness T3 of between about 250 and 300 nm. In one embodiment, a sufficient number of steps 154 at appropriate heights are formed so as to provide 10 to 50 nm increments from approximately 100 nm to approximately 600 nm. As a result, such differing thicknesses T1-T3 facilitate interferometer refraction of light, enabling substrate 126 to be provided as part of an interferometer such as in a display device or a spectrometer sensing device.

In other embodiments, such thicknesses may have other values depending upon the particular differing wavelengths of light to either be formed or sensed or depending upon the refractive index of substrate 126.

As further shown by FIG. 7, after steps 154 have been formed, layers 180 and 182 of partially reflective material are deposited our otherwise provided on an opposite side of substrate 126. Layer 182 is apposite or otherwise formed upon side 152 of substrate 126. Layer 182 is deposited or otherwise formed upon side 184 of substrate 126. In particular embodiments, layer 182 may be deposited or otherwise provided upon side 184 of substrate 126 prior to the formation of steps or 154 or even prior to embossed the of layer 128. As a result, the sacrificially treated substrate 126 end layers 180, 182 form an interferometer.

FIG. 8 illustrates spectrometer 186 formed from the interferometer shown in FIG. 7. In particular, as shown in FIG. 8, optical detectors 188A, 188B and 188C (collectively referred to as optical detectors 188) are mounted or otherwise formed across from each of steps and 154A, 154B and 154C of substrate 126. In one embodiment optical detectors 188 are photodiodes and each of the optical detectors 188 is substantially similar to one another. However, each of optical detectors 188 is configured to sense different wavelengths of light due to the unique Fabry-Perot etalons created by substrate 126 and partial reflectors number 180, 182 above each optical detectors 188. As indicated by arrows 190A, 190B and 190C, incident light is partially reflected in partially refracted by layers 180 and 182 of the partially reflective material. The particular wavelength of light that are reflected and refracted varies depending upon such thicknesses T1-T3 (shown in FIG. 7). Optical detectors 188 sense and detect light that is passed through substrate 126 and layers 180, 182.

For example, in one embodiment, step 154A causes refraction and filtering of light such that optical detector 188A is impinged by wavelengths of light in the red spectrum of visible light. Step 154B causes refraction and filtering of light such that optical detector 188B is impinged by wavelengths of light in the green spectrum of visible light. Step 154C causes refraction and filtering of light such that optical detector 188C is impinged by wavelengths of light in the blue spectrum of visible light. In other embodiments where substrate 126 includes additional steps 154 such as where substrate 126 includes 16 such steps 154 and 16 corresponding optical detectors 188 may be provided to sense other or narrower bands of light. In other embodiments, greater or fewer of such steps may be provided.

FIG. 9 is a sectional view schematically illustrating spectrometer 286, another embodiment of spectrometer 186. Spectrometer 286 is similar to spectrometer 186 except that spectrometer 286 includes embossed layer 128 in addition to substrate 126. Spectrometer 286 is formed in a similar fashion as spectrometer 186 except that the embossed layer 128 and substrate 126 as shown in FIG. 6 do not undergo sacrificial treatment. Rather, layers 180 and 182 are deposited or otherwise provided on opposite sides of substrate 126 and the embossed layers 128. Layer 182 is deposited or otherwise provided adjacent to side 184 of substrate 126. Layer 180 is deposited or otherwise provided upon steps 144 which have been embossed into layer 128. In such an embodiment, substrate 126 and layer 128 are both formed from one or more transparent materials. Although each of steps 144 are illustrated as being formed upon layer 128, in some embodiments, one of steps 144 may alternatively be embossed so as to extend adjacent to substrate 126. In such an embodiment, because substrate 126 does not undergo sacrificial treatment, substrate 126 may be much thinner. In particular embodiments, substrate 126 may be omitted.

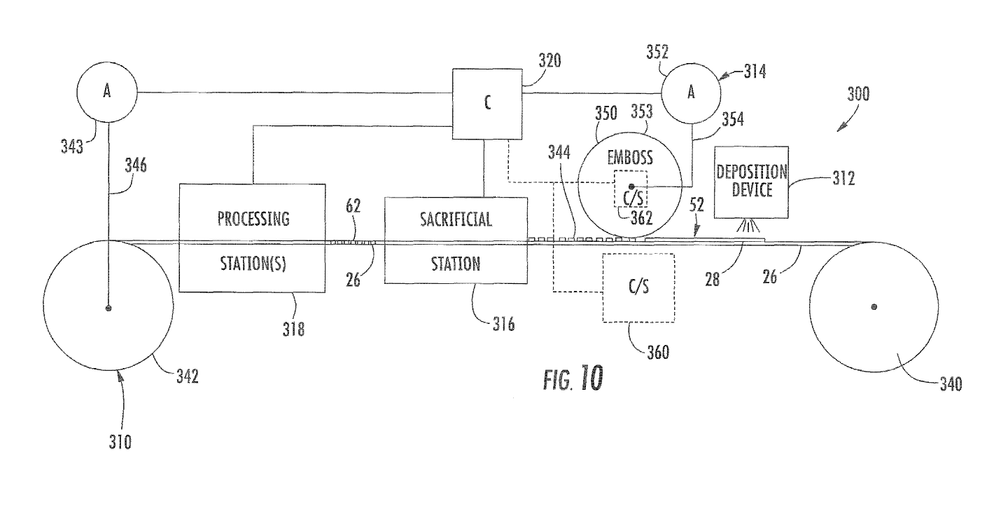

FIG. 10 schematically illustrates fabrication system 300 according to an example embodiment. Fabrication system 300 is configured to fabricate or form devices or components, such as electrical devices or optical devices, having a patterned or three-dimensional surface. System 300 forms such three-dimensional surfaces in a manner such that there is less reliance upon photolithography, reducing fabrication cost and complexity.

As shown by FIG. 10, system 300 includes substrate transport 310, deposition device 312, embossing station 314, sacrificial station 316, processing station 318 and controller 320. Substrate transport 310 comprises a device or mechanism configured to transport or move substrate 26 across and relative to deposition device 312, embossing station 314, sacrificial station 316 and processing station 318. In the example illustrated, substrate transport 310 comprises a reel-to-reel transport mechanism which includes supply reel 340, take a reel or 342 and actuator 343. Supply reel 340 comprises a reel, spool or winding of substrate 26.

Take-up reel 342 comprises a reel, spool or winding configured to receive substrate 26 after substrate 26 has been treated or further fabricated by system 300. Reels 340 and 342 cooperate to provide a web of substrate 26 which extends opposite to deposition device 312, embossing station 314, sacrificial station 316 and processing station 318. One or more additional support structures, driven rollers or idling rollers (not shown) 80 provided between reels 340 and 342 for assisting in the support and movement of substrate 26.

Actuator 343 comprises a motor or other source of torque operably coupled to take up reel 342 or another drive roller intermediate reels 340 and 342 by a transmission 346 (schematically shown). Actuator 343 rotationally drives the intermediate drive roller and take-up reels 342 to move substrate 26 across the other stations system 300. Because substrate 26 is applied and moved during treatment in a reel-to-reel process, fabrication of structures using substrate 26 may be more efficient.

In other embodiments, substrate transport 310 may have other configurations for handling substrate 26. For example, in one embodiment, take-up reel 342 may be omitted, wherein other rollers are used for driving substrate 26 and wherein other devices are provided for stamping or severing completed portions of the web of substrate 26 from the remaining web of substrate 26 being fed from reel 340. In yet other embodiments, substrate 26 may be transported between such stations by carriages, trays, conveyors, belts or other conveying mechanisms. In particular embodiments, substrate 26 may be manually position with respect to the various stations of the system 300.

Deposition device 312 comprises a device configured to provide embossable layer 28 upon substrate 26. In one environment, deposition device 312 is configured to spray, coat or reject the materials of embossable layer 28 onto substrate 26. In another embodiment, embossable layer 28 may be provided as a film or web which is laminated to substrate 26 by fusion, adhesion and the like.

In some embodiments, embossing layer 28 may be provided on substrate 26 prior to unwinding of substrate 26 from reel 340. In such an embodiment, deposition device 312 may comprise a device configured to alter the state of layer 28 or treat layer 28 such a layer 28 changes from a more solid or rigid state in which layer 28 is not embossable to an embossable state. In other embodiments, layer 28 may be in an embossable state while wound about reel 340.

Embossing station 314 comprises a station at which layer 28 is embossed to provide layer 28 was a three-dimensional pattern or arrangement of features 344, such as multiple steps 44. In the particular example illustrated, embossing station or 314 includes an embossing roller 350 and an actuator or 352. Embossing roller 350 includes a circumferential surface 353 having formed therein a relief pattern. The relief pattern is configured so as to imprint or emboss layer 28 to form features 344 as roller 350 is rolled into contact with layer 28. Actuator 352 comprises a motor or other source of torque operably coupled to roller 350 by transmission 354. Actuator 352 drives embossing roller 350 against and along layer 28 in a controlled fashion. In some embodiments, actuator 352 may be omitted, wherein movement of substrate 26 is sufficient to rotate embossing roller 350.

In yet other embodiments, embossing station 314 may have other configurations. For example, in other embodiments, embossing station or 314 may comprise a substantially planar relief surface which is reciprocated in a direction substantially perpendicular to substrate 26 and layer 28 so as to stamp features 344 into layer 28. In another embodiment, embossing station 314 may utilize a curved or arcuate embosser which is pivoted or rolled against layer 28 to embossed layer 28.

As indicated in broken lines, in some embodiments where layer 28 is not thixotropic or receives additional external treatment to enhance solidification or curing, system 300 may additionally include a cure or solidification mechanism 360 and/or cure or solidification mechanism 362. In one embodiment, mechanism 360 is located on an underside of substrate 26 opposite to the embosser (roller 350) of embossing station 314. Mechanism 360 treats substrate 26 and layer 28 to assist in curing or solidification of layer 28. In one embodiment, mechanism 360 may apply heat. In another embodiment, mechanism 360 may emit or provide electromagnetic radiation, such as UV light, wherein the UV light is transmitted through substrate 26 to cure or layer 28 while layer 28 is in contact with the embosser of embossing station 314.

Mechanism 362 comprises a device on the same side of substrate 26 as layer 28. Mechanism 362 is configured to a treat layer 28 through the embosser (roller 350) of embossing station 314. In one embodiment, mechanism 362 applies heat through thermally conductive portions of the embosser while the embosser is in contact with layer 28. In another embodiment, mechanism 362 applies electromagnetic radiation, such as UV light, through the embosser to cure layer 28. In such an embodiment, the embosser may be transparent. In embodiments where layer 28 is formed from one or more thixotropic materials such that layer 28 retains its shape after being separated from the embosser of embossing station 314, mechanisms 360 or 362 may be positioned downstream from embossing station 314 or may be omitted.

Sacrificial station 316 comprises device configured to apply a sacrificial treatment to embossed layer 28 and the supporting substrate 26. In one embodiment, sacrificial station 316 applies one or more etchants to side 52 of substrate 26 and layer 28. In another embodiment, station 316 applies energy to side 52 of substrate 26 and layer 28. In one embodiment, layer 28 is completely sacrificed and selected portions of substrate 26 are sacrificed (removed). In other embodiments, portions of layer 28 are sacrificed and portions of substrate 26 are sacrificed. As discussed above with respect to FIGS. 1-3, such sacrificial treatment results in a multitude of features 62 in substrate 26. Such features facilitate use of substrate 26 as part of a variety of electronic and optical devices or components.

Processing Station 318 comprises one or more processing stations wherein further treatment or additional materials are added to remaining portions of substrate 26 after sacrificial treatment. For example, in one embodiment, processing station 318 may include one or more stations configured to apply layers of partially reflective material to opposite side of substrate 26 to form interferometric devices. Individual dies or interferometric platforms may be severed from the webbing of substrate 26. In particular embodiments, station 318 includes a station wherein optical detectors, such as optical detectors 188, are formed upon one side of substrate 26 to form spectrometers, such as spectrometer 186. In particular embodiments, processing station 318 may be omitted.

Controller 320 comprises one or more processing units configure to generate control signals directing operation of actuator 343, actuator 352, curing or solidification mechanism 360, sacrificial station 316 and processing Station 318. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 320 may be embodied as part of one or more application-specific integrated circuits (ASICs). Unless otherwise specifically noted, the controller is not limited to any specific combination of hardware circuitry and software, nor to any particular source for the instructions executed by the processing unit.

Overall, system 300 and the methods 20, 120 (shown in FIGS. 1-8) provide efficient and repeatable fabrication of a structure having three-dimensional features with less reliance on photolithography. The embossment of layer 28 or layer 128 forms a pattern which selectively insulates the underlying substrate 26 or substrate 126 from agents of the sacrificial treatment to varying extents such that the underlying substrate 26 or substrate 126 is patterned based on the embossed pattern. The embossed pattern serves as a mask for patterning the underlying substrate 26 or substrate 126. Consequently, generally more expensive and time-consuming photolithography steps may be reduced or eliminated.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
providing an embossable material upon a substrate;
embossing the material; and
sacrificing at least portions of the embossed material and the substrate to concurrently form multiple levels, at least one of which is in the substrate.

2. The method of claim 1, wherein the embossing forms a first set of embossed levels in the material and wherein the sacrificing forms a second set of sacrificially formed levels in at least the substrate corresponding to the first levels.

3. The method of claim 2, wherein the first set of embossed levels includes a first embossed level and a second embossed level having heights that differ by a first difference and wherein the second set of sacrificially formed levels includes a first sacrificially formed level and a second sacrificially formed level corresponding to the first embossed level and the second embossed level, respectively, wherein the first sacrificially formed level and the second sacrificially formed level have heights that differ by a second difference distinct from the first difference.

4. The method of claim 2, wherein the second set of sacrificially formed levels is formed in both the embossable material and the substrate.

5. The method of claim 2, wherein the second set of sacrificially formed levels is formed solely in the substrate.

6. The method of claim 1, wherein the substrate is formed from one or more non-embossable materials.

7. The method of claim 1, wherein the embossing forms greater than two embossed levels on a first side of the substrate.

8. The method of claim 1, wherein a substrate is provided in a reel-to-reel process.

9. The method of claim 1 further comprising curing the embossable material by applying electromagnetic radiation through an embosser.

10. The method of claim 1 further comprising curing the embossable material by applying electromagnetic radiation through the substrate.

11. The method of claim 1 further comprising forming a partial reflector on opposite sides of the substrate after the sacrificing.

12. The method of claim 1, wherein the etching forms multiple levels in the substrate and wherein the method further comprises coupling an optical detector adjacent to each of the multiple levels.

13. The method of claim 1, wherein the embossable material and the substrate are sacrificed at different rates during the sacrificing.

14. The method of claim 1, wherein the sacrificing comprises etching.

15. A method comprising:
embossing a structure including a substrate and an embossable material upon the substrate with a single embosser having greater than two levels;
forming a partial reflector on opposite sides of the substrate; and
coupling optical detectors adjacent levels formed in the structure.

16. The method of claim 15 further comprising etching the embossable material and the substrate after embossing to form the levels.

17. The method of claim 16, wherein the levels are solely formed in the substrate.

18. An apparatus comprising:
a deposition device configured to deposit an embossable material upon a substrate;
an embosser configured to emboss the embossable material; and
a sacrificial station configured to sacrifice both the embossable material and the substrate to concurrently form multiple levels, at least one of which is in the substrate.

19. The apparatus of claim 18 further comprising a transport configured to move this substrate relative to the deposition device, the embosser and the sacrificial station.

20. The apparatus of claim 19, wherein the transport comprises a driven reel-to-reel arrangement.
